(19) United States
(12) Patent Application Publication
(10) Pub. No.: US 2019/0275511 A1
(43) Pub. Date: Sep. 12, 2019

(54) THETA PIPETTE EMITTER AND METHOD THEREFOR

(71) Applicant: The Trustees of Indiana University, Indianapolis, IN (US)

(72) Inventors: Lane A. BAKER, Bloomington, IN (US); Anumita SAHA-SHAH, Philadelphia, PA (US); Jonathan A. KARTY, Bloomington, IN (US)

(21) Appl. No.: 16/291,420

(22) Filed: Mar. 4, 2019

Related U.S. Application Data
(60) Provisional application No. 62/639,012, filed on Mar. 6, 2018.

(51) Int. Cl. B01L 3/02; G01Q 60/60; G01N 27/416; B01J 19/00

(52) U.S. Cl. CPC B01L 3/021; G01Q 60/60; B82Y 35/00; B01J 19/0046; B01J 2219/00371; G01N 27/416

(57) ABSTRACT

A theta pipette is provided having an outer barrel defining a cavity. A first inner barrel may be positioned within the cavity of the outer barrel and may contain an aqueous solution. An electrode may be inserted into the acidified aqueous solution. A second inner barrel may be positioned within the cavity of the outer barrel and may contain an immiscible phase solution. The second inner barrel may be positioned adjacent the first inner barrel.

### CROSS-REFERENCE TO RELATED APPLICATIONS

This application claims priority under 35 U.S.C. § 119(e) to U.S. Provisional Patent Application Ser. No. 62/369012, filed Mar. 6, 2018, which is expressly incorporated by reference herein.

### BACKGROUND

The present disclosure relates generally to pipettes, and particularly to theta pipettes for “collect-react-analyze” measurements of small volumes of a sample collected locally from biological samples.

Nano- and micropipettes have found widespread use in patch clamp studies and microinjections, which represent some of the earliest applications of pipettes in single-cell analysis. Since then pipette-based nanofluidic devices have found application as probes for local electrochemical analysis, scanning probe microscopy, surface charge mapping, and nanoliter fluid manipulation. Utilization of pipettes in spatial and temporal measurement of biological events holds potential when combined with a universal detector such as a mass spectrometer, which enables parallel and highthroughput analysis of multiple analytes simultaneously.

Recently, the utility of pipettes toward the study of reaction kinetics, MS analysis of single cells and studies of intercellular heterogeneity has been demonstrated. The scope of these nanofluidic devices towards local chemistry on cells and biological surfaces for targeted analysis of metabolites may be expanded via mass spectrometry. Mass spectrometry often relies on reaction chemistry to enhance the peak intensity of target analytes. Chemical derivatizations are hence invaluable for mass spectrometric analysis. Incorporation of such derivatization techniques with single cell analysis methods can be beneficial to analyze molecules of interest. Comprehensive analysis of all metabolites, lipids, and other small molecules from single cells may present a challenge, primarily, because of small sample amounts and diversity of targets. A need remains to increase both spatial resolution and detection sensitivity of analysis such that comprehensive analysis of single cell constituents can be performed.

Known strategies to electrospray small volumes of the sample from a micropipette tip include coating the outside wall of the glass pipette with a conductive metal coating, and backfilling the pipette with an acidified solution post-sample collection. However, most of these strategies have poor stability or drawbacks related to sample dilution.

### SUMMARY

The disclosed embodiments show that addition of di-cationic ion pairing compounds to a sampling solution increases an overall ionization efficiency of metabolites collected from single cells. A method is provided to collect samples with a small pipette, react the collected material with a chemical agent (e.g. acid, or a derivatizing reagent) and analyze the products of the reaction by mass spectrometry.

This method, described as “collect-react-analyze”, is used to perform localized reaction chemistry on single cells to increase detection sensitivity of target analytes. The peak intensity of minor metabolites such as flavonoids from single Allium cepa cells may be enhanced by chemical degradation of major components (oligosaccharides) in the cell sample. Moreover, new signals may be detected and analyzed as a result of effective protonation of the neutral molecules and simplification of the spectra.

Furthermore, selective derivatization of cis-diols via boronic acid complexation may be utilized to detect oligosaccharides in individual cells. The identity of oligosaccharide-phenyl boronic acid complexes may be confirmed by tandem MS(MS/MS) analysis. Small tip orifice pipettes may enable a low electrospray flow rate, allowing electrospray of few nanoliters of the cytoplasm over 5 min to perform tandem MS analyses. Oligosaccharides may serve as model compounds to demonstrate functional aspects of the technique towards local chemistry inside single cells. Finally, the principle of this “collect-react-analyze” approach may be used for selective derivatization of rhamnolipids (a class of liposaccharides implicated in quorum sensing for bacteria) from P. aeruginosa biofilms.

According to an aspect of the disclosed embodiments, a theta pipette includes an outer barrel defining a cavity. A first inner barrel may be positioned within the cavity of the outer barrel and may contain an aqueous solution. An electrode may be inserted into the aqueous solution. A second inner barrel may be positioned within the cavity of the outer barrel and may contain an immiscible phase solution. The second inner barrel may be positioned adjacent the first inner barrel.

In some embodiments, the immiscible phase solution may be perfluorodecalin.

In some embodiments, the sample may be configured to be collected in the second inner barrel. The sample may be collected in the second inner barrel through pressure actuation. The outer barrel may include a tip. A meniscus of the first inner barrel may contact the tip of the outer barrel. A meniscus of the second inner barrel may contact the tip of the outer barrel. The meniscus of the first inner barrel and the meniscus of the second inner barrel may be configured to enable electrospray ionization of the sample when potential is applied to a mass spectrometer inlet.

In some embodiments, the outer barrel may have an inside diameter of approximately 100 nanometers to 1 micrometer.

In some embodiments, the first inner barrel may be filled with ultrapure water.

According to another aspect of the disclosed embodiments, a method of analyzing a sample collected with a theta pipette includes puncturing and aspirating a sample from a cell with a theta pipette having an outer barrel. The method may also include mixing the sample with a reagent contained in a first inner barrel of the outer barrel. The method may also include collecting the sample in a second inner barrel of the outer barrel. The second inner barrel may contain an immiscible phase solution. The method may also include performing electrospray ionization of the sample to a mass spectrometer when potential is applied to a mass spectrometer inlet.

In some embodiments, the immiscible phase solution may be perfluorodecalin.

In some embodiments, the method may also include collecting the sample in the second inner barrel through pressure actuation.

According to another aspect of the disclosed embodiments, an assembly for analyzing a sample may include a container for housing the sample. A theta pipette may include an outer barrel defining a cavity. A first inner barrel may be positioned within the cavity of the outer barrel and contain an aqueous solution. An electrode may be inserted into the aqueous solution. A second inner barrel may be positioned within the cavity of the outer barrel and contain an immiscible phase solution. The second inner barrel may be positioned adjacent the first inner barrel. A mass spectrometer may have an inlet. The sample may be transferred to the inlet of the mass spectrometer through electrospray ionization when potential is applied to a mass spectrometer inlet.

In some embodiments, the immiscible phase solution may be perfluorodecalin.

In some embodiments, the sample may be configured to be collected in the second inner barrel. The sample may be collected in the second inner barrel through pressure actuation. The outer barrel may include a tip. A meniscus of the first inner barrel may contact the tip of the outer barrel. A meniscus of the second inner barrel may contact the tip of the outer barrel. The meniscus of the first inner barrel and the meniscus of the second inner barrel may be configured to enable electrospray ionization of the sample when potential is applied to a mass spectrometer inlet.

In some embodiments, the outer barrel may have an inside diameter of approximately 100 nanometers to 1 micrometer.

In some embodiments, the first inner barrel may be filled with ultrapure water.

### BRIEF DESCRIPTION

The detailed description particularly refers to the following figures, in which:

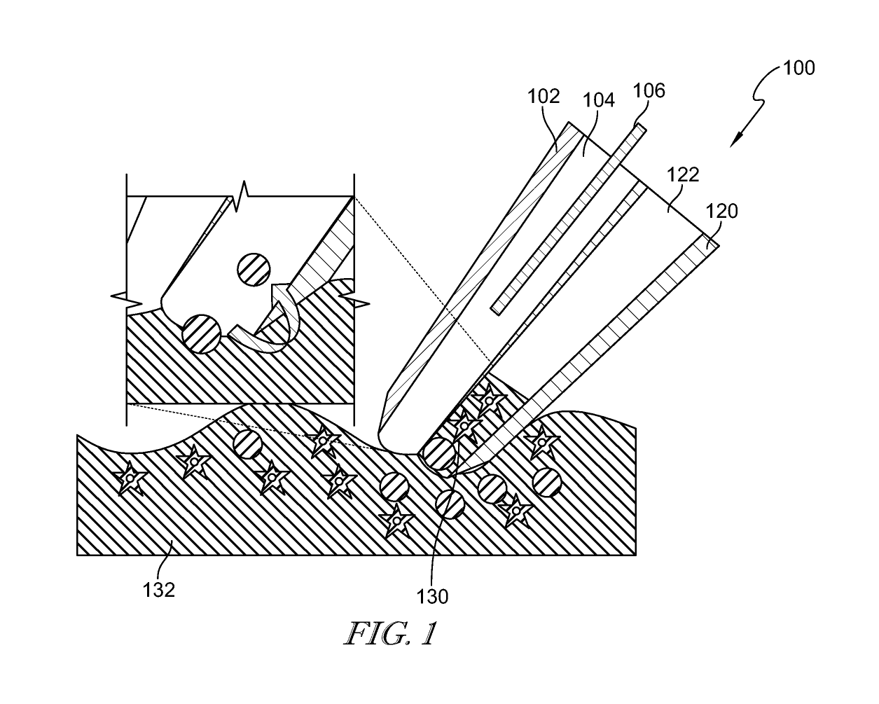

FIG. 1 is a schematic showing an embodiment for performing local chemistry, wherein analyte molecules are aspirated inside one barrel of a pipette and selective reaction is performed inside a tip of the pipette.

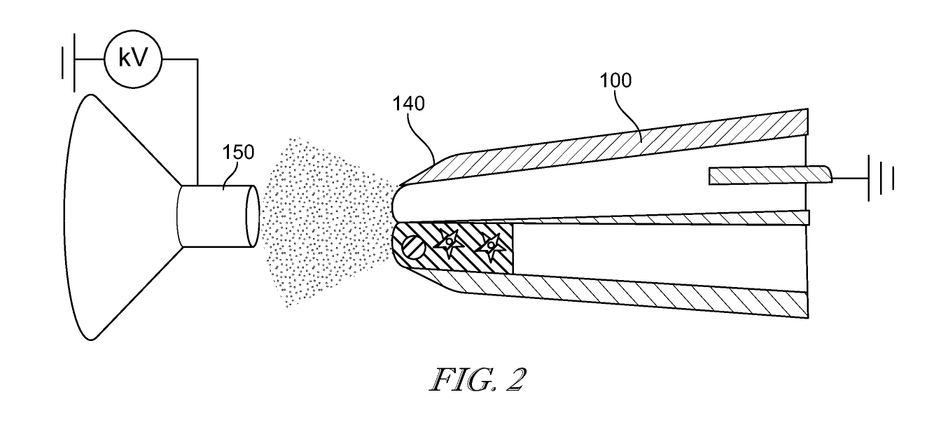

FIG. 2 is a schematic showing an embodiment for electrospray ionization of nanoliter volumes collected at the pipette tip.

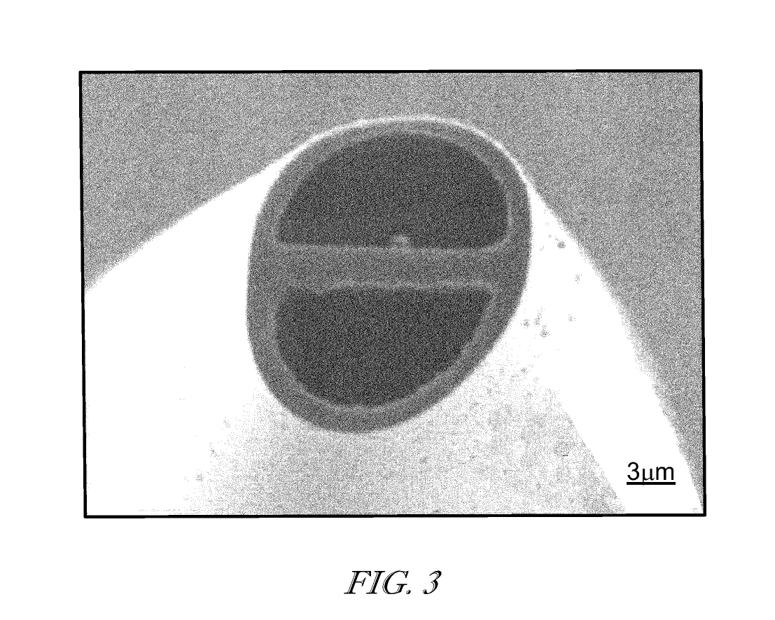

FIG. 3 illustrates a scanning electron micrograph showing an end-on view of a representative pipette tip.

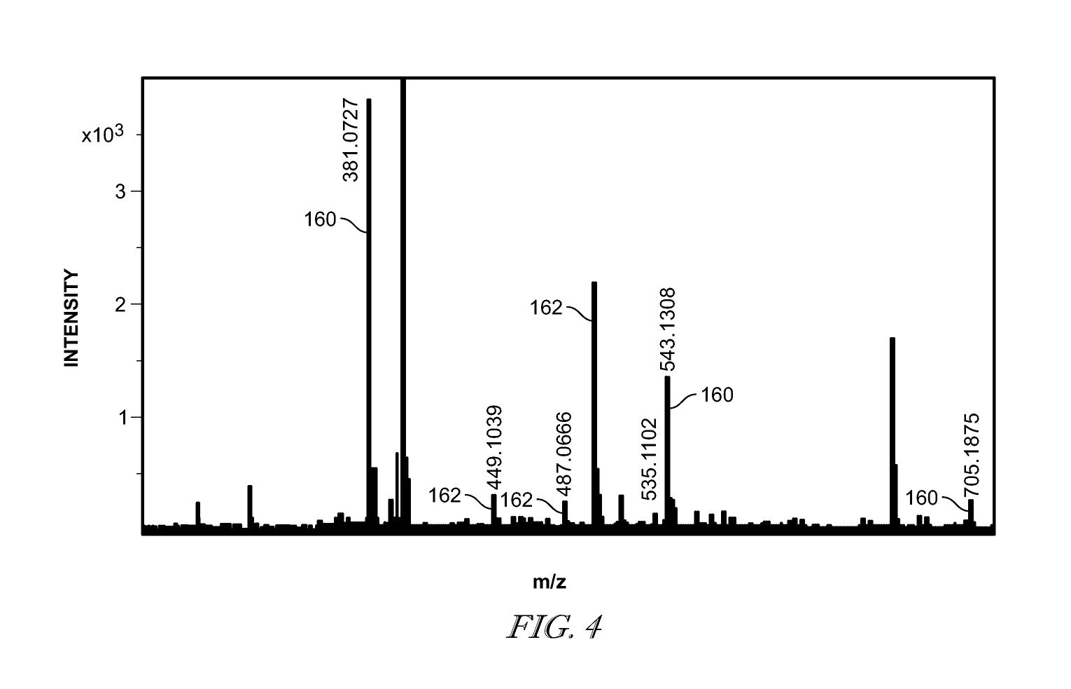

FIG. 4 illustrates a mass spectrum of a single red Allium cepa cell before acid catalysed degradation of oligosaccharides.

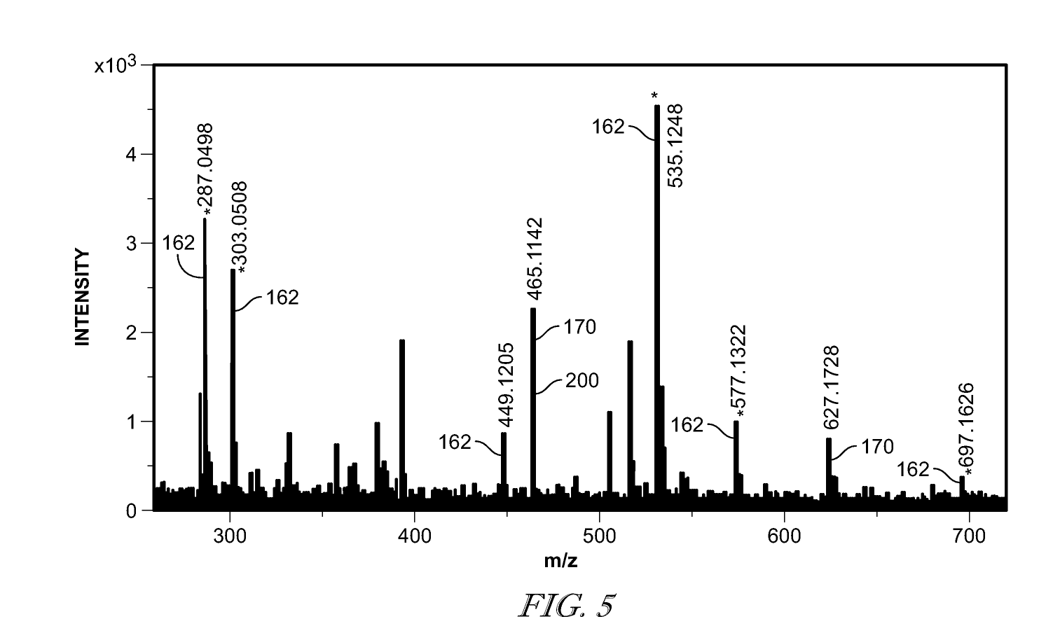

FIG. 5 illustrates a mass spectrum of a single red Allium cepa cell after acid catalysed degradation of oligosaccharides.

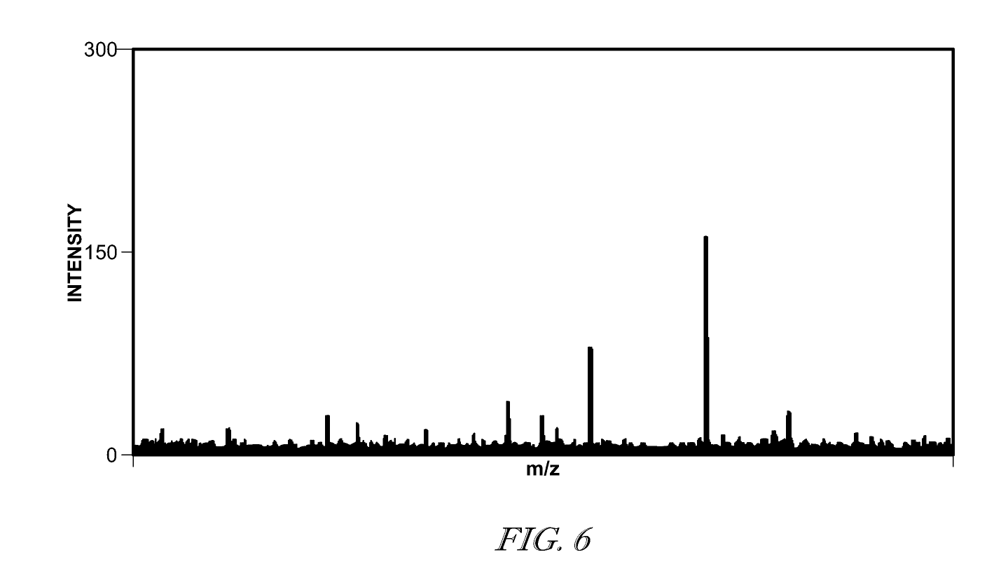

FIG. 6 illustrates a mass spectrum (lower mass range) of a single red Allium cepa cell before acid catalyzed degradation of oligosaccharides.

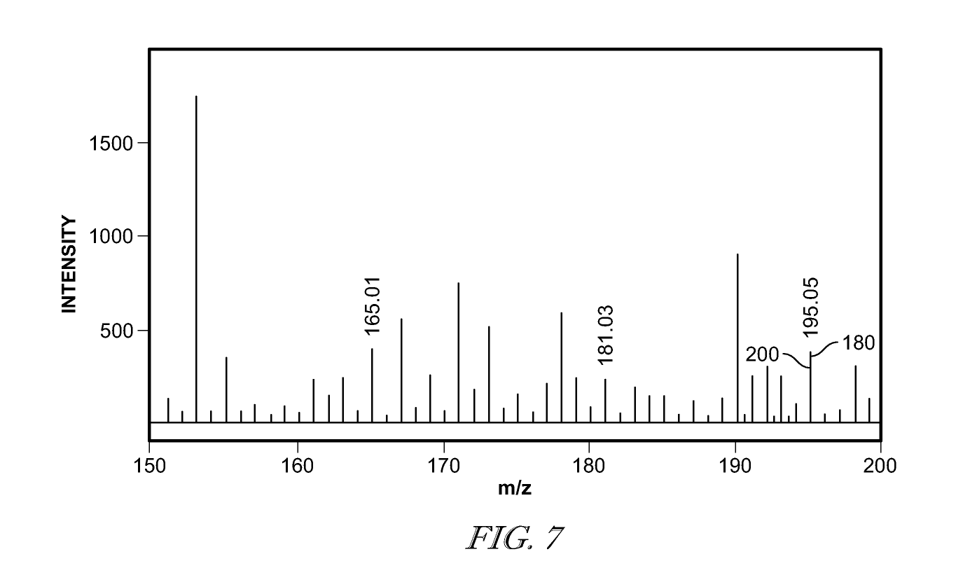

FIG. 7 illustrates a mass spectrum (lower mass range) of a single red Allium cepa cell after acid catalyzed degradation of oligosaccharides.

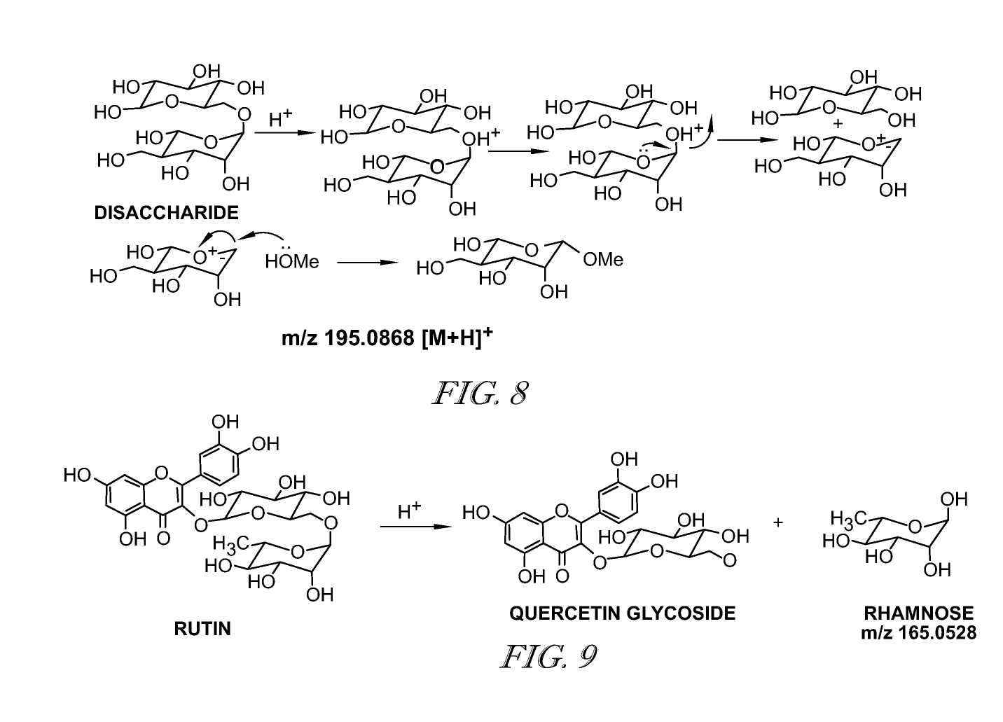

FIG. 8 illustrates acid catalyzed degradation of oligosaccharides and nucleophilic addition of the methoxy group.

FIG. 9 illustrates acid catalyzed degradation of rutin.

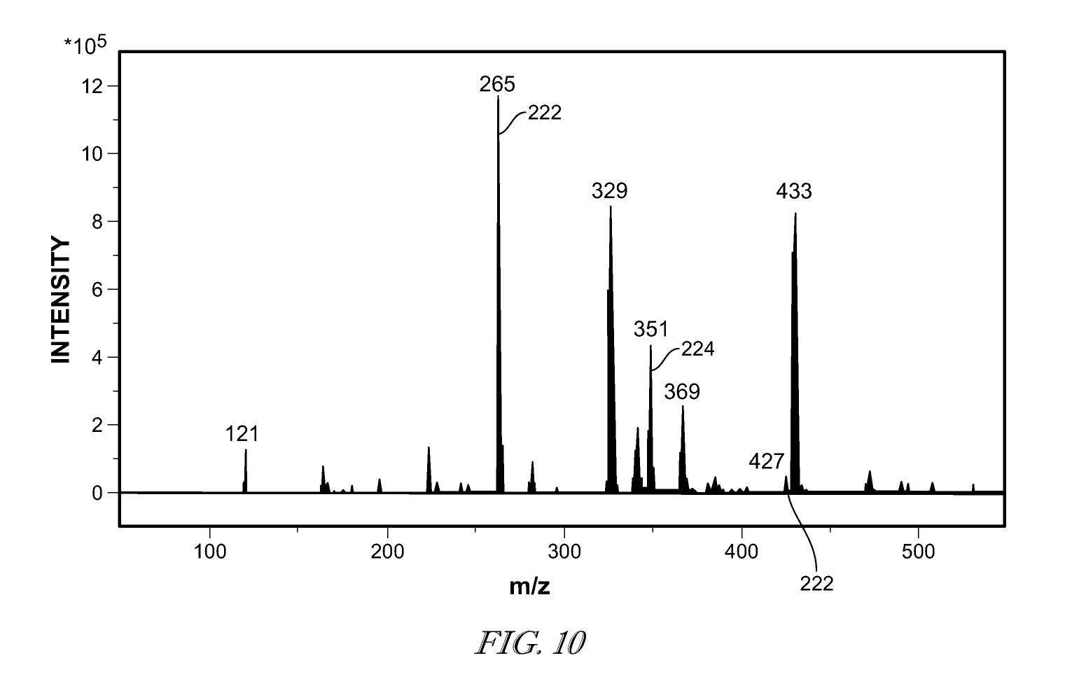

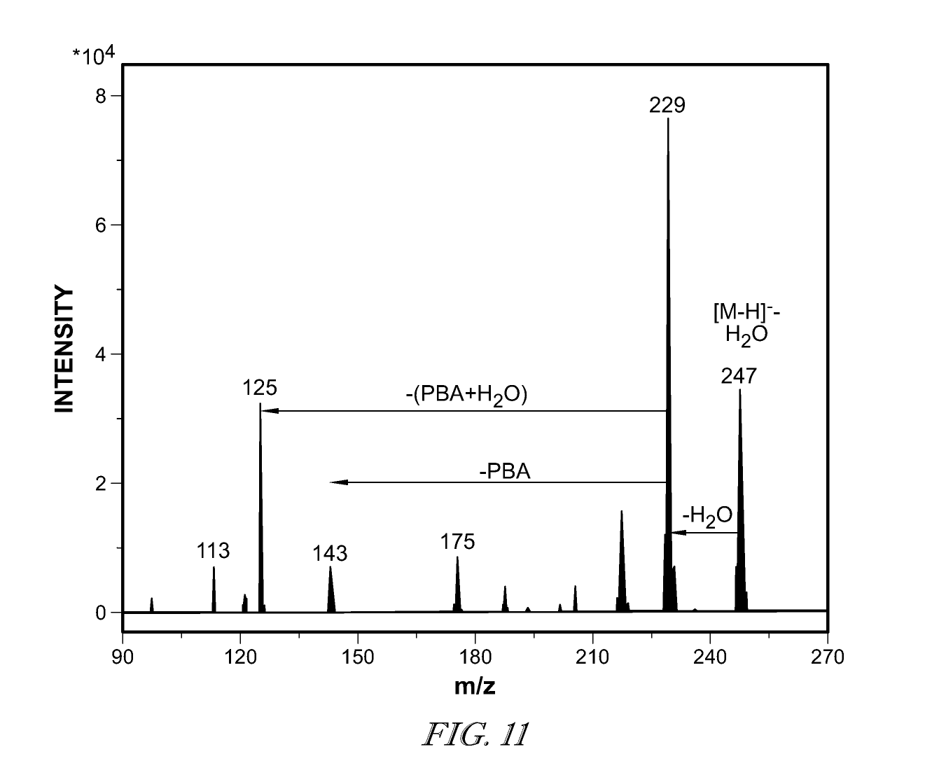

FIG. 10 illustrates a mass spectrum of a sample from a single Allium cepa cell after treatment with phenylboronic acid (PBA), wherein the peak at 265 is for the monosaccharide-PBA complex, the peak at 351 is for the bis-monosaccharide-PBA complex, and the peak at 427 is for the disaccharide-PBA complex.

FIG. 11 illustrates a Tandem MS (MS2) spectra of m/z 265 (trisaccharide-PBA complex).

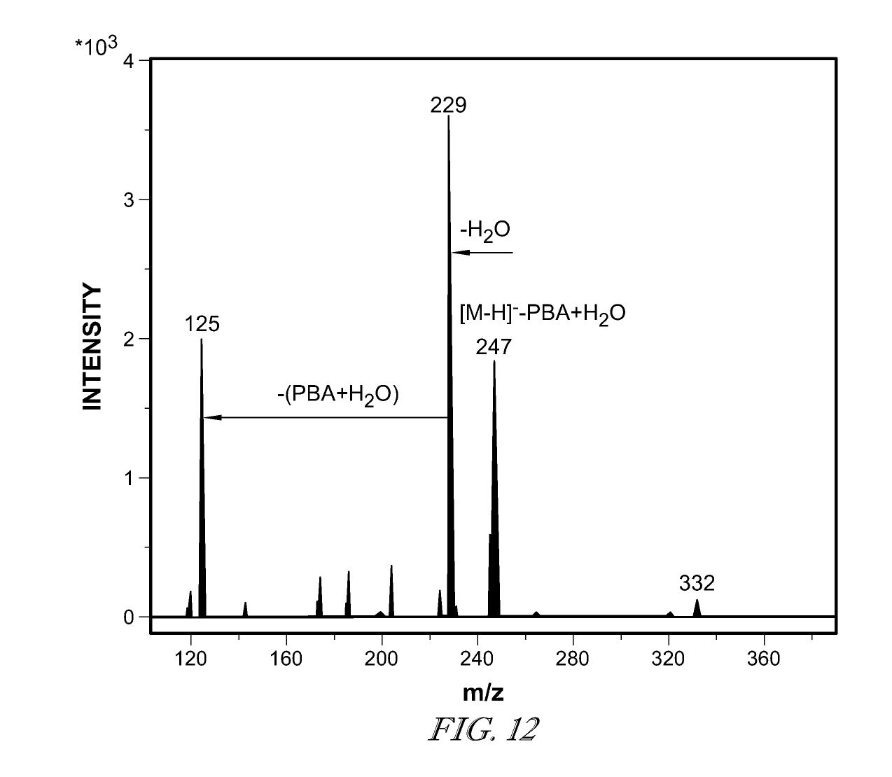

FIG. 12 illustrates a Tandem MS (MS2) spectra of m/z 351 (trisaccharide-PBA complex).

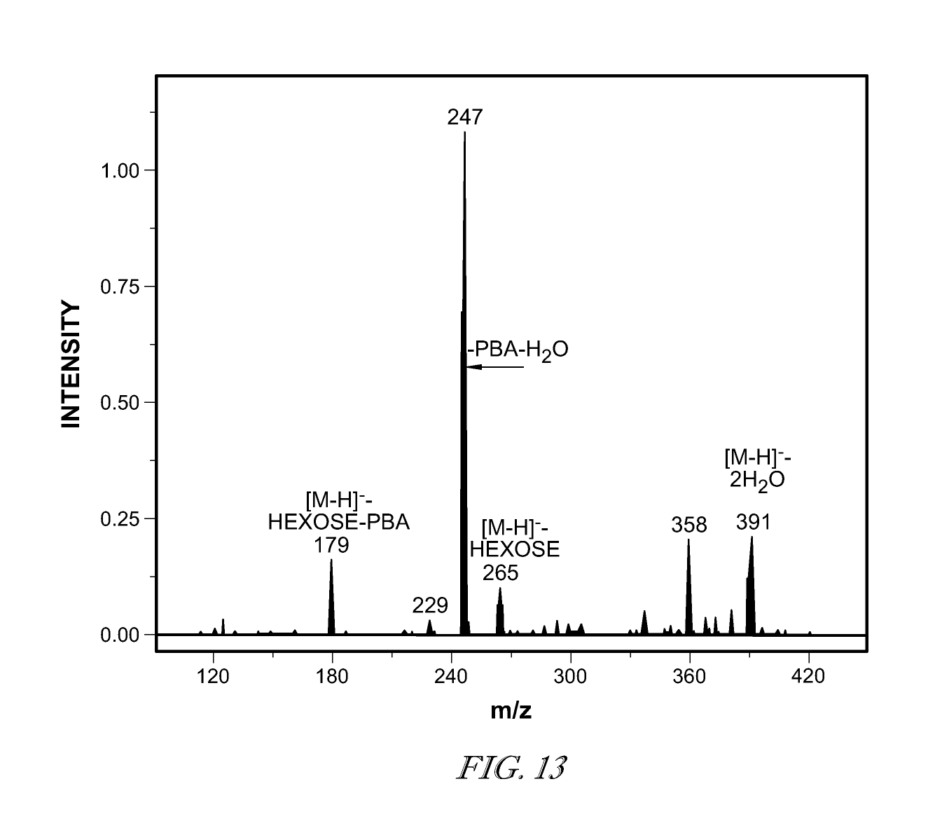

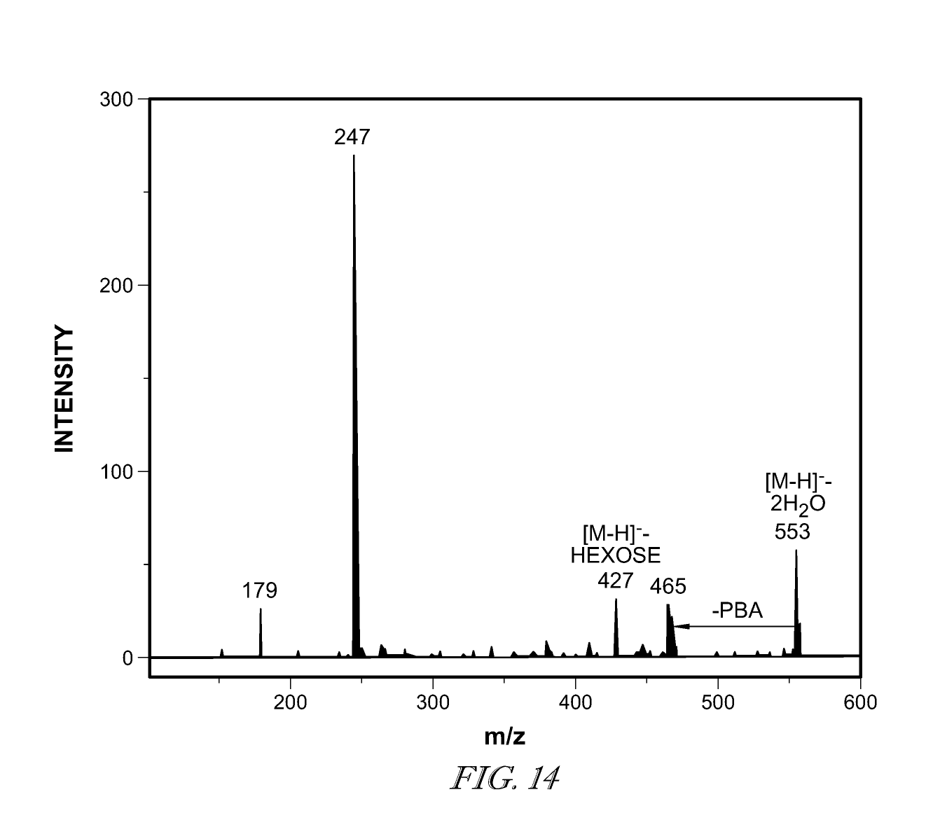

FIG. 13 illustrates a Tandem MS (MS2) spectra of m/z 427 (trisaccharide-PBA complex).

FIG. 14 illustrates a Tandem MS (MS2) spectra of and m/z 589 (trisaccharide-PBA complex).

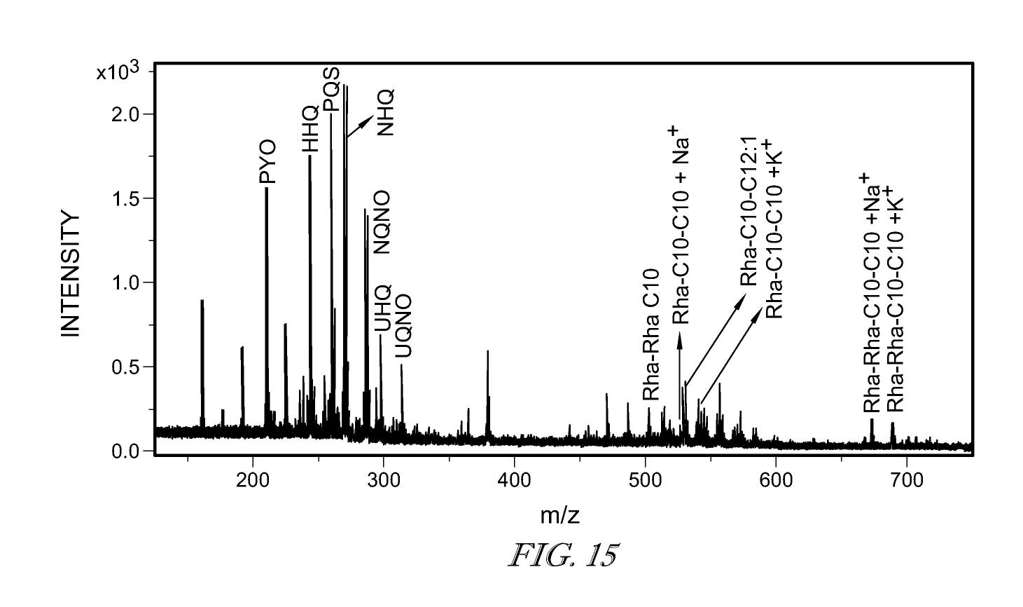

FIG. 15 illustrates a mass spectrum showing metabolites, lipids and liposaccharides extracted from a 200 μm spot in a P. aeruginosa biofilm using spray solution (methanol-water-acetic acid, 70:30:0.1) filled pipettes.

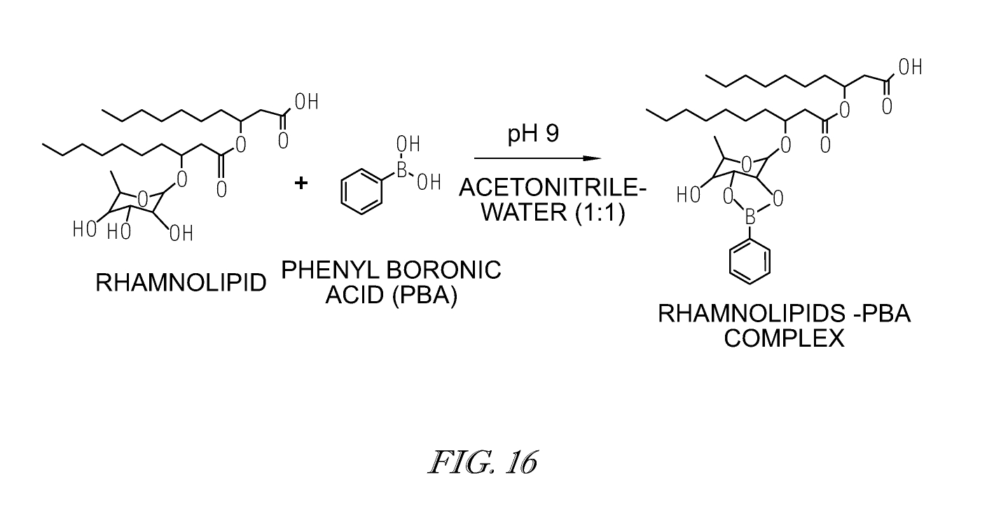

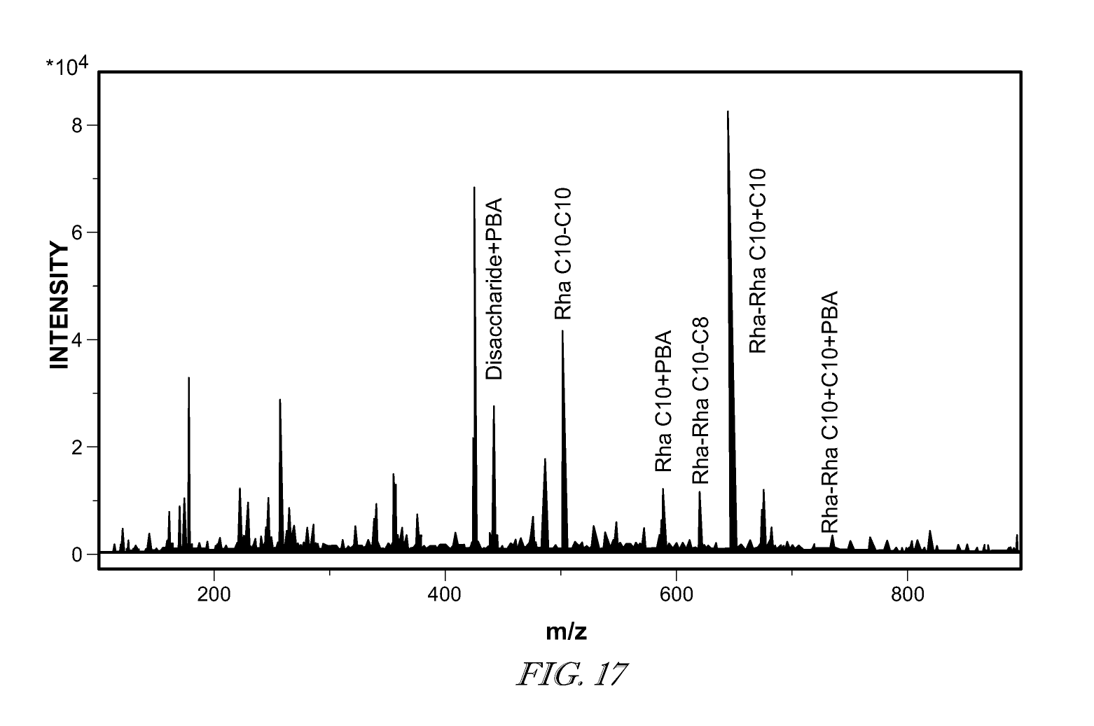

FIG. 16 illustrates rhamnolipid-phenylboronic acid complexation.

FIG. 17 illustrates a negative-ion mode mass spectrum from a 200 μm (diameter) spot of a P. aeruginosa biofilm showing rhamnolipid peaks post-PBA derivatization.

### DETAILED DESCRIPTION

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

It should be appreciated that Local collection, reaction and analysis with theta pipette emitters, Anumita Saha-Shah, Jonathan A. Karty and Lane A. Baker, The Royal Society of Chemistry 2017, Analyst, 2017, 142, 1512-1518, is herein incorporated by reference in its entirety.

A mobile nanofluidic device based on theta pipettes is provided for “collect-react-analyze” measurements of small volumes of a sample collected locally from biological samples. Specifically, execution of local reactions inside single cells and on Pseudomonas aeruginosa biofilms may be demonstrated for targeted analysis of metabolites. Nanoliter volumes of the sample, post-reaction, may be delivered to a mass spectrometer via electrospray ionization (ESI) for chemical analysis. An additional barrel of a theta pipette may be utilized both to enable chemical manipulations after sample collection and to electrospray the nanoliter sample volumes collected directly from the pipette tip. A method is provided for ESI from nanometer sized tips without clogging or degradation of the emitter, thereby obviating the need to coat glass pipettes with a conductive metal coating. Chemical reactions included acid catalyzed degradation of oligosaccharides inside the pipette tip to increase the detection sensitivity of minor metabolites found in Allium cepa cells. Additionally, phenylboronic acid complexation of carbohydrates from single cells and liposaccharides from biofilms may also be performed inside the pipette tip for selective detection of carbohydrates and liposaccharides with cis-diols.

Referring to FIG. 1, a theta capillary 100 having a 1.2 mm outer diameter and a 0.9 mm inner diameter was used for pipette fabrication. In some embodiments, a laser based pipette puller may be used for pipette fabrication. After pipette fabrication, one barrel 102 of the pipette is filled with aqueous solution 104 containing a reagent. A platinum wire 106 is inserted into the barrel to serve as an electrode for initiating electrospray. A second barrel 120 is filled with perfluorodecalin (PFD) 122 which is immiscible with both water and organic solvents. The PFD barrel 120 of the pipette is connected to polyethylene tubings pre-filled with methanol-water-acetic acid via a stainless steel needle. The junction between the quartz capillary and polyethylene tubing is sealed with epoxy glue to form a microfluidic channel. The distal end of the polyethylene tubing is connected to a gas-tight syringe for applying negative pressure to the aspirate sample. Pipettes are mounted on a pipette positioning system and the pipette position, during sampling, is controlled by a controller having software to operate the positioning system. The pipette is utilized to puncture and aspirate cytoplasm 130 from a single cell 132. Mixing of the cytoplasm with the reagent solution during the sampling process (aspiration of reagent solution from electrolyte barrel to the sampling barrel due to application of negative pressure) and at the meniscus facilitates a reaction. The pipette is then mounted on the electrospray interface and the sample is delivered to the mass spectrometer. P. aeruginosa biofilms are then grown.

The mass spectrometer is used in positive ion mode for analysis of A. cepa samples. The capillary inlet may be maintained at −1.5 kV and the ground wire may be connected to the back end of the theta pipette. The pipette is positioned ˜0.5 to 1 mm away from the inlet. Temperature of the capillary interface may be set at 190° C. and spectra may be acquired at a rate of 3 Hz (scanned from m/z 100-2000). Calibration is performed with sodium trifluoroacetate prior to analysis. A similar source is used for tandem MS (MS/MS) analyses with an ultra ion trap. +1.0 kV may be applied on the heated capillary and ions may be activated for 40 ms in smart fragment mode at a qz of 0.25.

To address the existing shortcomings of electrospray strategies, the disclosed embodiments provide a method to electrospray nanoliter volumes of the sample from pipette tips employing theta pipettes. One barrel of the pipette was filled with acidified aqueous solution and an electrode was inserted into this barrel as shown in FIG. 1 (this barrel is referred to as the electrolyte containing barrel throughout the rest of this disclosure). The other barrel of the pipette was filled with PFD which acted as an immiscible phase. Pressure actuation was used to collect the sample inside the PFD containing barrel. The meniscus of the electrolyte containing barrel and the PFD barrel, containing the sample, come into contact at the tip 140 of the pipette 100, facilitating electrospray ionization of the sample when potential was applied to the mass spectrometer inlet 150 as shown in FIG. 2. This setup provides a robust method for electrospray from pipettes as small as 100 nm (i.d.).

The electrolyte barrel of the pipette is utilized for the delivery of reagents to perform local reactions inside single cells. Shown in FIG. 4 is the mass spectrum of the native cytoplasm collected from a single A. cepa cell. The electrolyte barrel of the pipette is filled with ultrapure water. Major peaks 160 observed in this spectrum are assigned to hexose oligosaccharides. Acid catalyzed degradation of oligosaccharides enables removal of the oligosaccharide peaks and hence facilitates the analysis of the minor metabolites such as anthocyanins 162 and flavonoids. Selective degradation of oligosaccharides is accomplished by utilizing an acidic solution of methanol-water-acetic acid (70:30:0.1) in the electrolyte barrel. The sampling barrel is filled with PFD for pneumatically driven sample collection.

The time required for sampling and mounting the probe on the ESI interface is in the order of minutes. Hence, the reaction likely takes place at the meniscus during sample collection and probe handling rather than during ESI. Although, acid catalyzed depolymerization of carbohydrates has been explored widely, usually, more harsh conditions may be necessary for depolymerization. One of the contributing factors for the above observation could be the fact that oligosaccharides in Allium cepa are present in the form of fructans which are reported to be highly susceptible to acids. To substantiate acid catalyzed hydrolysis, dextrans (˜15 nL of 1 mg mL-1 solution) are subjected to similar degradation conditions inside the pipette tip and the same results (hydrolysis of dextrans) are obtained as A. cepa samples.

FIG. 5 illustrates a positive ion-mode mass spectrum of the A. cepa cytoplasm following acid catalyzed degradation of oligosaccharides. Apart from the disappearance of the oligosaccharide peaks, an increase in the signal intensity of the anthocyanin peaks 162 is observed. Additionally, new peaks 170 corresponding to neutral flavonoids such as rutin (m/z 649.1456), quercetin glycoside (m/z 465.1090) and quercetin diglycoside (m/z 627.1632) are observed. The presence of acid in the environment enables effective protonation of the neutral flavonoid molecules and results in the increase of the corresponding signal intensity. Anthocyanins are positively charged molecules and their ionization is generally not dependent on protonation. A reduction in S/N was observed after treatment of the sample with acidified methanol and could be contributed by contaminants from the organic solvent and acid or precipitation of salts and other organics (due to the presence of 70% methanol).

Careful inspection of the spectra at a low mass range following degradation of oligosaccharides revealed a peak 180 at m/z 195.05 (FIG. 7) which could be a side product of acid catalyzed degradation. The peak 180 at m/z 195.05 is not found in the spectra where the cytoplasm is collected under conditions non-conducive to acid catalyzed degradation of oligosaccharides (FIG. 7). FIG. 8 shows the mechanism by which a peak at m/z 195 can be formed. A peak at m/z 195 can also be formed from a monosaccharide and does not solely indicate degradation of oligosaccharides but suggests that a similar mechanism could be operating on oligomers which results in degradation. The mass difference between the observed peaks and theoretical mass is found to be negative and higher at the low mass range for both samples and standards (FIGS. 6-7) and is contributed by limitations of instrument tuning.

Under acidic conditions, the glycosidic bond of rutin (found in abundance in A. cepa) is also prone to degradation (FIG. 9) and can give rise to quercetin glycoside 200 (m/z 465.1090) as seen in FIG. 5 and rhamnose sugar 202 (m/z 165.01) as seen in FIG. 7. Quercetin glycoside also occurs naturally in A. cepa and hence the peak 200 observed in FIG. 5 could arise from degradation of rutin and naturally ccurring quercetin glycoside. Hence, comparison of the native sample and the sample after the reaction may be crucial to capture all the changes due to addition of the reagent.

Cis-Diol is a ubiquitous functional group found in abundance in carbohydrates, steroids, liposaccharides and glycopeptides. To expand the scope of the nanofluidic device to perform selective derivatization of cis-diols, oligosaccharides present in cytoplasm collected from A. cepa are treated with phenylboronic acid (PBA), which leads to the formation of an oligosaccharide-boronic (S-B) acid complex. Phenylboronic acid has a natural abundance of boron (1:4) which creates a unique isotopic pattern easily distinguishable from the mass spectra. The negative ion-mode spectra of the cytoplasm collected from a single cell with a pipette based nanofluidic device and subjected to the reaction with phenylboronic acid is shown in FIG. 10. The electrolyte barrel of the pipette is filled with a pH=9 solution of acetonitrile-water (1:1, pH adjusted with sodium hydroxide). The PFD barrel is utilized to aspirate a small amount of 10 μM solution of phenyl boronic acid solution prepared in a pH 9 solution of acetonitrile-water. The pipette is then utilized to puncture a cell and aspirate the cytoplasm. This embodiment avoids strong peaks arising from phenylboronic acid dimers and trimers.

Based on isotope patterns, four peaks 222 are assigned to S-B complexes. The peaks are as follows: peaks at m/z 265, m/z 427 and m/z 589 correspond to PBA-hexose, PBA-disaccharide and PBA-trisaccharide complexes, respectively. At m/z 351, a bis PBA complex 224 of hexose is observed. All the S-B complexes were subsequently subjected to tandem MS analysis as shown in FIGS. 11-14 and the structures of the molecules were confirmed. In FIG. 11, the fragment at m/z 245 arises from the loss of a water molecule from the S-B complex. In FIGS. 13-14, m/z 391 and m/z 553 arises from the loss of two water molecules from the S-B complex, respectively. Detections of peaks at m/z 265 and m/z 427 in FIGS. 13-14 are strong indications for S-B complexes. To further validate the identity of S-B complexes, standard dextran, galactose solution and a bulk extract of A. cepa are subjected to the reaction with phenylboronic acid to obtain the same peaks. The S-B complexes formed from standard dextran are subjected to MS/MS analysis and the same fragments are obtained as those obtained from A. cepa oligosaccharides.

Selective derivatization of molecules of interest may be useful when analyzing a complex mixture such as extracts from P. aeruginosa biofilms (FIG. 15). P. aeruginosa is a human pathogen which forms biofilms to make antibiotic treatment ineffective and is a major concern for the health care industry. This bacterium can cause infection in immunocompromised patients suffering from acquired immunodeficiency syndrome, cancer, burn wounds, organ transplants and complicates patient treatment in cystic fibrosis leading to severe pulmonary inflammation and damage. Rhamnolipids are a special class of glycolipids found in P. aeruginosa biofilms and are implicated in virulence determination of this bacteria and biofilm formation. Rhamnolipids consist of a glycosyl (rhamnose) head group and a lipid tail as shown in FIG. 16.

Detection of rhamnolipids in biofilm samples may be critical to determine their virulence factor. The glycosyl head groups in rhamnolipids are utilized for phenylboronic acid complexation which leads to easy detection of these molecules from a complex mixture through the unique isotopic signature of boron.

As illustrated in FIG. 15, a sample is collected from a ˜200 μm spot (spot diameter is 200 μm) of the biofilm. In positive ion-mode, several phenazines, quinolones, lipids and rhamnolipids are detected. These peaks are tentatively assigned by mass comparison with previous reports. To identify rhamnolipids, from complex spectra as shown in FIG. 15, selective derivatization may be useful. In some embodiments, pressure assisted delivery of solvent on a flat sample surface is followed by aspiration of the dissolved analytes inside the pipette. The electrolyte barrel is filled with a pH 9 mixture of acetonitrile-water and the sampling barrel is filled with <10 nL of 10 μM solution of phenylboronic acid. A small positive pressure is applied to deliver phenylboronic acid solution on an ˜200 μm spot of the biofilm. The solvent containing reagent-analyte complex is then aspirated back into the pipette and delivered to the mass spectrometer by electrospray ionization.

FIG. 17 illustrates a negative ion-mode mass spectrum of a sample collected from the biofilm post-phenylboronic acid complexation. Phenylboronic acid complexes of rhamnolipids are detected at 86 mass units apart from the nonmodified versions as seen in the spectra. Rhamnolipids are known as natural surfactants and are known to form high molecular weight aggregates under the reaction conditions. As a result, the reaction between phenylboronic acid and rhamnolipids is not driven to completion. Nevertheless, sufficient conversion is achieved so that rhamnolipids can be identified from the unique isotopic pattern of boron and the presence of peaks 86 mass units apart (native peak and PBA complex appear 86 mass unit apart).

The disclosed embodiments demonstrate a new “collect-react-analyze” strategy to perform electrospray with nanoliter volumes of the sample collected at the theta pipette tips. The embodiments avoid an expensive and time consuming step of coating pipettes with conductive gold coating and are found to be a highly robust method for electrospray from nanometer sized pipettes. Additionally, the embodiments avoid steps that lead to excessive dilution of the sample. Pipette based nanofluidic devices are further developed to perform local chemistry at the single cell level and on flat surfaces such as biofilms for targeted degradation or derivatization of metabolites. The cytoplasm collected from single A. cepa cells are treated with phenylboronic acid to form oligosaccharide-phenylboronic acid complexes for targeted analysis of oligosaccharides. Additionally, efficient detection of minor metabolites, such as flavonoids from A. cepa cells, is performed by acid catalyzed degradation of oligosaccharides.

Local processing or chemistry on cells and tissue sections can find application in various fields of science such as life science research and diagnostics. The embodiments when combined with simultaneous detection of multiple analytes can provide a wealth of information useful for various applications. The pipette based nanofluidic device of the disclosed embodiments is conducive to easy coupling with mass spectrometric analysis and holds potential to find applications in biochemistry and clinical research.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

There are a plurality of advantages of the present disclosure arising from the various features of the method, apparatus, and system described herein. It will be noted that alternative embodiments of the method, apparatus, and system of the present disclosure may not include all of the features described yet still benefit from at least some of the advantages of such features. Those of ordinary skill in the art may readily devise their own implementations of the method, apparatus, and system that incorporate one or more of the features of the present invention and fall within the spirit and scope of the present disclosure as defined by the appended claims.

1. A theta pipette comprising:
an outer barrel defining a cavity,
a first inner barrel positioned within the cavity of the outer barrel and containing an aqueous solution, wherein an electrode is inserted into the aqueous solution, and
a second inner barrel positioned within the cavity of the outer barrel and containing an immiscible phase solution, the second inner barrel positioned adjacent the first inner barrel.

2. The theta pipette of claim 1, further comprising an immiscible phase solution such as perfluorodecalin.

3. The theta pipette of claim 1, wherein a sample is configured to be collected in the second inner barrel.

4. The theta pipette of claim 1, wherein the sample is collected in the second inner barrel through pressure actuation.

5. The theta pipette of claim 3, wherein:
the outer barrel includes a tip, and
a meniscus of the first inner barrel contacts the tip of the outer barrel.

6. The theta pipette of claim 4, wherein:
the outer barrel includes a tip, and
a meniscus of the second inner barrel contacts the tip of the outer barrel.

7. The theta pipette of claim 5, wherein the meniscus of the first inner barrel and the meniscus of the second inner barrel are configured to enable electrospray ionization of the sample when potential is applied to a mass spectrometer inlet.

8. The theta pipette of claim 1, wherein the outer barrel has an inside diameter of approximately 100 nanometers to 1 micrometer.

9. The theta pipette of claim 1, wherein the first inner barrel is filled with ultrapure water.

10. A method of analyzing a sample collected with a theta pipette, the method comprising:
puncturing and aspirating a sample from a cell with a theta pipette having an outer barrel,
mixing the sample with a reagent contained in a first inner barrel of the outer barrel,
collecting the sample in a second inner barrel of the outer barrel, wherein the second inner barrel contains an immiscible phase solution, and
performing electrospray ionization of the sample to a mass spectrometer when potential is applied to a mass spectrometer inlet.

11. The method of claim 10, further comprising an immiscible phase solution such as perfluorodecalin.

12. The method of claim 10, further comprising collecting the sample in the second inner barrel through pressure actuation.

13. An assembly for analyzing a sample, the assembly comprising:
a container for housing the sample,
a theta pipette comprising:
an outer barrel defining a cavity,
a first inner barrel positioned within the cavity of the outer barrel and containing an aqueous solution, wherein an electrode is inserted into the aqueous solution, and
a second inner barrel positioned within the cavity of the outer barrel and containing an immiscible phase solution, the second inner barrel positioned adjacent the first inner barrel, and
a mass spectrometer having an inlet, wherein the sample is transferred to the inlet of the mass spectrometer through electrospray ionization when potential is applied to a mass spectrometer inlet.

14. The assembly of claim 13, wherein the pipette includes an immiscible phase solution such as perfluorodecalin.

15. The assembly of claim 13, wherein a sample is configured to be collected in the second inner barrel.

16. The assembly of claim 15, wherein the sample is collected in the second inner barrel through pressure actuation.

17. The assembly of claim 15, wherein:
the outer barrel includes a tip, and
a meniscus of the first inner barrel contacts the tip of the outer barrel.

18. The assembly of claim 17, wherein:
the outer barrel includes a tip, and
a meniscus of the second inner barrel contacts the tip of the outer barrel.

19. The assembly of claim 17, wherein the meniscus of the first inner barrel and the meniscus of the second inner barrel are configured to enable electrospray ionization of the sample when potential is applied to a mass spectrometer inlet.

20. The assembly of claim 13, wherein the first inner barrel is filled with ultrapure water.
